(19) United States
(12) Patent Application Publication
(10) Pub. No.: US 2026/0336432 A1
(43) Pub. Date: Oct. 29, 2026

(54) LOCATION FEATURE DESIGN

(71) Applicant: GM Global Technology Operations LLC, Detroit, MI (US)

(72) Inventors: Lu Huang, Troy, MI (US); Collins Angelo, Windsor (CA); Nathan Sigmund, Clinton Township, MI (US); Xiaosong Huang, Novi, MI (US); Rodrigo Franca Soares Campos, Rochester Hills, MI (US); Joseph Williams, Washington Twp, MI (US)

(21) Appl. No.: 19/188,530

(22) Filed: Apr. 24, 2025

(51) Int. Cl. B60L 50/64; B21D 39/03; F16B 5/04; H01M 50/224; H01M 50/262; H01M 50/276

(52) U.S. Cl. CPC B60L 50/64; H01M 50/224; H01M 50/262; H01M 50/276; B21D 39/031; B21D 39/032; F16B 5/045

(57) ABSTRACT

A sheet metal component assembly includes a primary component having a top surface that defines a first plane, a bottom surface that defines a second plane, and a locating boss formed therein and extending upward from the top surface and having an outer side wall, wherein a portion of the outer side wall that extends above the first plane is vertical relative to the first plane, and a secondary component including a locating opening formed therein, and wherein, the locating boss of the primary component engages the locating opening formed within the secondary component to position the secondary component relative to the primary component.

### INTRODUCTION

The present invention relates generally to assemblies of two components, for example, vehicle components such as rechargeable energy storage systems (RESS's) or battery systems, for vehicles.

A typical RESS assembly includes a cover secured thereto. The assembly process of this cover to the RESS assembly relies on manual operations to properly locate the cover to the RESS assembly, in particular to a tray of the RESS. The manual process is not compatible with assembly facilities with a high degree of automation. RESS assemblies that include a locating feature allow precise location of the components, however, formation of location features leaves a fillet radius at the point of formation that interferes with assembly of the cover to the RESS assembly.

Thus, while current systems and methods achieve their intended purpose, there is a need for an improved locating boss formed within a primary component, such as a tray of the RESS, that allows the locating boss to engage a secondary component, such as the cover of the RESS, for precise location of the primary component and the secondary component relative to one another and does not interfere with assembly of and engagement between the primary component and the secondary component.

### SUMMARY

According to several aspects of the present disclosure, a sheet metal component assembly includes a primary component having a top surface that defines a first plane, a bottom surface that defines a second plane, and a locating boss formed therein and extending upward from the top surface and having an outer side wall, wherein a portion of the outer side wall that extends above the first plane is vertical relative to the first plane, and a secondary component including a locating opening formed therein, and wherein, the locating boss of the primary component engages the locating opening formed within the secondary component to position the secondary component relative to the primary component.

According to another aspect, the top surface of the primary component includes a recessed channel extending along and immediately adjacent to the locating boss such that a fillet radius of the locating boss is positioned below the first plane.

According to another aspect, the top surface of the primary component is in direct contact with an adjacent surface of the secondary component.

According to another aspect, the primary component includes an offset portion extending along and immediately adjacent to the locating boss and extending below the second plane, the offset portion defining the recessed channel within the top surface of the primary component.

According to another aspect, a nominal thickness of the primary component and a thickness of the offset portion are uniform.

According to another aspect, no portion of the bottom surface of the primary component extends below the second plane.

According to another aspect, a portion of the primary component that defines the recessed channel within the top surface of the primary component has a thickness that is less than a nominal thickness of the primary component.

According to another aspect, the locating boss includes a tapered profile tip.

According to another aspect, the locating boss includes portions that are folded over onto the secondary component to secure the secondary component in position relative to the primary component.

According to another aspect, the locating boss includes one of, one of a continuous cylindrical or conical wall, discontinuous flanges, or a combination of a continuous wall and discontinuous flanges.

According to several aspects of the present disclosure, a rechargeable energy storage system (RESS) includes a primary component that defines a tray and includes a top surface that defines a first plane, a bottom surface that defines a second plane, and a locating boss formed therein and extending upward from the top surface and having an outer side wall, the top surface of the primary component including a recessed channel extending along and immediately adjacent to the locating boss such that a fillet radius of the locating boss is positioned below the first plane, wherein a portion of the outer side wall that extends above the first plane is vertical relative to the first plane, one or more RESS cells positioned within the primary component, and a secondary component that defines a cover installed onto the primary component wherein the top surface of the primary component is in direct contact with an adjacent surface of the secondary component to enclose the RESS cells within the RESS, the secondary component including a locating opening formed therein, and wherein, the locating boss of the primary component engages the locating opening formed within the secondary component to position the secondary component relative to the primary component.

According to several aspects of the present disclosure, a vehicle has a rechargeable energy storage system (RESS) operably connected to a propulsion system of the vehicle, the RESS including a primary component that defines a tray and includes a top surface that defines a first plane, a bottom surface that defines a second plane, and a locating boss formed therein and extending upward from the top surface and having an outer side wall, the top surface of the primary component including a recessed channel extending along and immediately adjacent to the locating boss such that a fillet radius of the locating boss is positioned below the first plane, wherein a portion of the outer side wall that extends above the first plane is vertical relative to the first plane, one or more RESS cells positioned within the primary component, and a secondary component that defines a cover installed onto the primary component wherein the top surface of the primary component is in direct contact with an adjacent surface of the secondary component to enclose the RESS cells within the RESS, the secondary component including a locating opening formed therein, and wherein, the locating boss of the primary component engages the locating opening formed within the secondary component to position the secondary component relative to the primary component.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic view of a vehicle having a rechargeable energy storage system (RESS) according to an exemplary embodiment of the present disclosure;

FIG. 2 is a perspective view of a secondary component being assembled to a primary component according to an exemplary embodiment;

FIG. 3 is a sectional view of the RESS according to an exemplary embodiment;

FIG. 4 is an enlarged portion of FIG. 3, as indicated by the circled portion of FIG. 3 labelled “FIG. 4”;

FIG. 5 is an enlarged portion of FIG. 4, as indicated by the circled portion of FIG. 4 labelled “FIG. 5”;

FIG. 5A is an enlarged portion of FIG. 5, as indicated by the circled portion of FIG. 5 labelled “FIG. 5A”;

FIG. 6 is a view similar to FIG. 5 according to another embodiment of the present disclosure;

FIG. 7 is a view similar to FIG. 2, wherein the locating boss and locating opening have a generally square shape;

FIG. 8 is a sectional view similar to FIG. 4 wherein the primary component includes tapered profile tips; and

FIG. 9 is a sectional view similar to FIG. 4, wherein discontinuous flanges of the locating boss are folded over onto the secondary component.

The figures are not necessarily to scale and some features may be exaggerated or minimized, such as to show details of particular components. In some instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to variously employ the present disclosure.

### DETAILED DESCRIPTION

The following description is merely exemplary in nature and is not intended to limit the present disclosure, application, or uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality. Although the figures shown herein depict an example with certain arrangements of elements, additional intervening elements, devices, features, or components may be present in actual embodiments. It should also be understood that the figures are merely illustrative and may not be drawn to scale.

As used herein, the term “vehicle” is not limited to automobiles. While the present technology is described primarily herein in connection with automobiles, the technology is not limited to automobiles. The concepts can be used in a wide variety of applications, such as in connection with aircraft, marine craft, other vehicles, and consumer electronic components.

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about”, with reference to percentages, comprises a variation of plus/minus 5%, “about”, with reference to temperatures, comprises a variation of plus/minus five degrees, and “about”, with reference to distances, comprises plus/minus 10%. In addition, disclosure of ranges includes disclosure of all values and further divided ranges within the entire range, including endpoints and sub-ranges given for the ranges.

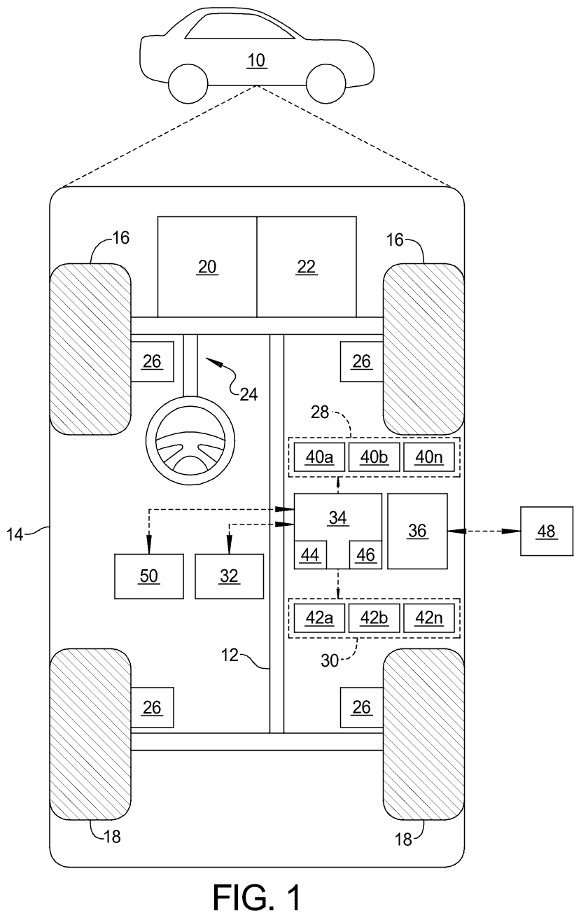

In accordance with an exemplary embodiment, FIG. 1 shows a vehicle 10 with an associated rechargeable energy storage system (RESS) 50 in accordance with the present disclosure. In general, the sheet metal component assembly 50 works in conjunction with other systems within the vehicle 10. The vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The front wheels 16 and rear wheels 18 are each rotationally coupled to the chassis 12 near a respective corner of the body 14.

In various embodiments, the vehicle 10 is an autonomous vehicle and the assembly 50 is incorporated into the autonomous vehicle 10. An autonomous vehicle 10 is, for example, a vehicle 10 that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), etc., can also be used. In an exemplary embodiment, the vehicle 10 is equipped with a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver. The novel aspects of the present disclosure are also applicable to non-autonomous vehicles.

As shown, the vehicle 10 generally includes a propulsion system 20, a transmission system 22, a steering system 24, a brake system 26, a sensor system 28, an actuator system 30, at least one data storage device 32, a vehicle controller 34, and a wireless communication module 36. In an embodiment in which the vehicle 10 is an electric vehicle, there may be no transmission system 22 and the propulsion system 20 is operably connected to the rechargeable energy storage system (RESS) 50 or battery. The propulsion system 20 may, in various embodiments, include an internal combustion engine, an electric machine such as a traction motor, and/or a fuel cell propulsion system. The transmission system 22 is configured to transmit power from the propulsion system 20 to the vehicle's front wheels 16 and rear wheels 18 according to selectable speed ratios. According to various embodiments, the transmission system 22 may include a step-ratio automatic transmission, a continuously-variable transmission, or other appropriate transmission. The brake system 26 is configured to provide braking torque to the vehicle's front wheels 16 and rear wheels 18. The brake system 26 may, in various embodiments, include friction brakes, brake by wire, a regenerative braking system such as an electric machine, and/or other appropriate braking systems. The steering system 24 influences a position of the front wheels 16 and rear wheels 18. While depicted as including a steering wheel for illustrative purposes, in some embodiments contemplated within the scope of the present disclosure, such as for a fully autonomous vehicle, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, and/or other sensors. In an exemplary embodiment, the plurality of sensing devices 40a-40n includes at least one of a motor speed sensor, a motor torque sensor, an electric drive motor voltage and/or current sensor, an accelerator pedal position sensor, a coolant temperature sensor, a cooling fan speed sensor, and a transmission oil temperature sensor. The actuator system 30 includes one or more actuator devices 42a-42n that control one or more vehicle 10 features such as, but not limited to, the propulsion system 20, the transmission system 22, the steering system 24, and the brake system 26.

The vehicle controller 34 includes at least one processor 44 and a computer readable storage device or media 46. The at least one data processor 44 can be any custom made or commercially available processor, a central processing unit (CPU), a graphics processing unit (GPU), an auxiliary processor among several processors associated with the vehicle controller 34, a semi-conductor based microprocessor (in the form of a microchip or chip set), a macro-processor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the at least one data processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

Although only one controller 34 is shown in FIG. 1, embodiments of the vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

The wireless communication module 36 is configured to wirelessly communicate information to and from other remote entities 48, such as but not limited to, other vehicles (“V2V” communication,) infrastructure (“V2I” communication), remote systems, remote servers, cloud computers, and/or personal devices. In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The vehicle controller 34 is a non-generalized, electronic control device having a preprogrammed digital computer or processor, memory or non-transitory computer readable medium used to store data such as control logic, software applications, instructions, computer code, data, lookup tables, etc., and a transceiver [or input/output ports]. Computer readable medium includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device. Computer code includes any type of program code, including source code, object code, and executable code.

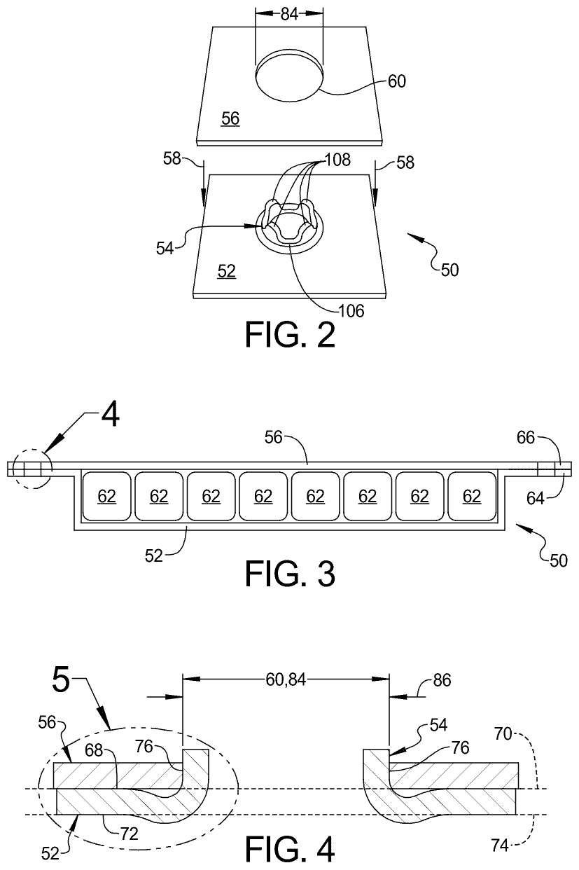

Referring to FIG. 2, a sheet metal component assembly 50 is shown wherein a primary component 52 includes a locating boss 54 formed therein and a secondary component 56 is placed onto the primary component 52, as indicated by arrows 58, wherein the locating boss 54 engages a locating opening 60 within the secondary component 56 to position the primary component 52 and the secondary component 56 relative to one another.

Referring to FIG. 3, in an exemplary embodiment the sheet metal component assembly 50 is a rechargeable energy storage system (RESS) 50. FIG. 3 is a cross-sectional view of an exemplary embodiment of a RESS assembly 50. The RESS assembly 50 includes a primary component 52 that defines a tray with a plurality of cells 62 disposed therein. The secondary component 56 defines a cover to enclose the RESS assembly 50. The primary component 52 includes a tray flange 64 that in some embodiments defines an outer perimeter of the primary component 52. Similarly, the secondary component 56 includes a cover flange 66 that in some embodiments defines an outer perimeter of the secondary component 56. In some embodiments, the primary component 52 and the secondary component 56 are formed from a sheet metal material. One skilled in the art, however, will readily appreciate that the primary component 52 and/or the secondary component 56 may be formed from another material such as a plastic or fiber reinforced composite material. While this arrangement is illustrated and described herein, one skilled in the art will readily appreciate that in some embodiments, the configuration may be substantially reversed, wherein the primary component 52 defines the cover of the RESS 50 and the secondary component 56 defines the tray of the RESS 50.

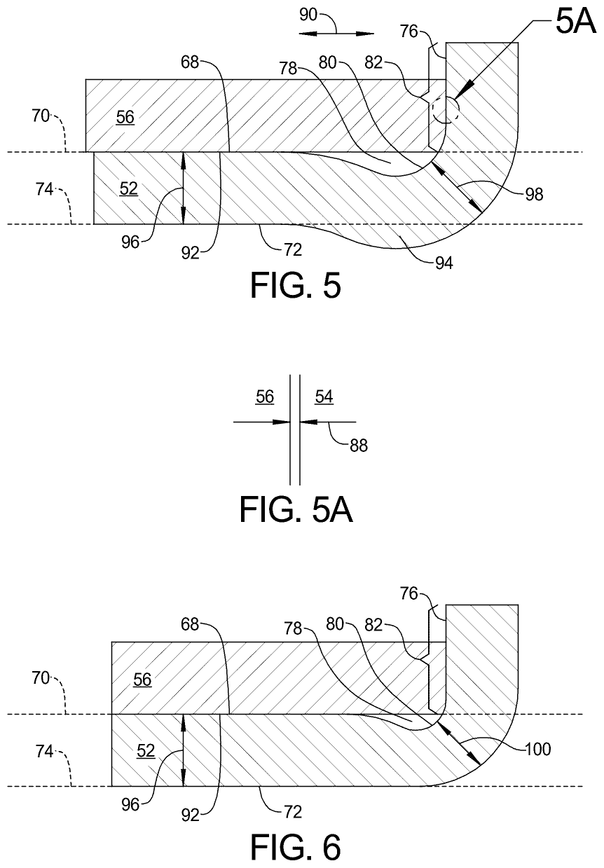

Referring to FIG. 4 and FIG. 5, the primary component 52 includes a top surface 68 that defines a first plane 70 and a bottom surface 72 that defines a second plane 74. The locating boss 54 is integrally formed with the primary component 52 and extends upward from the top surface 68. The locating boss 54 further includes an outer side wall 76. The top surface 68 of the primary component 52 includes a recessed channel 78 extending along and immediately adjacent to the locating boss 54 such that a fillet radius 80 of the locating boss 54 is positioned below the first plane 70 and a portion of the outer side wall 76 that extends above the first plane 70, as indicated at 82, is vertical relative to the first plane 70, which is horizontal.

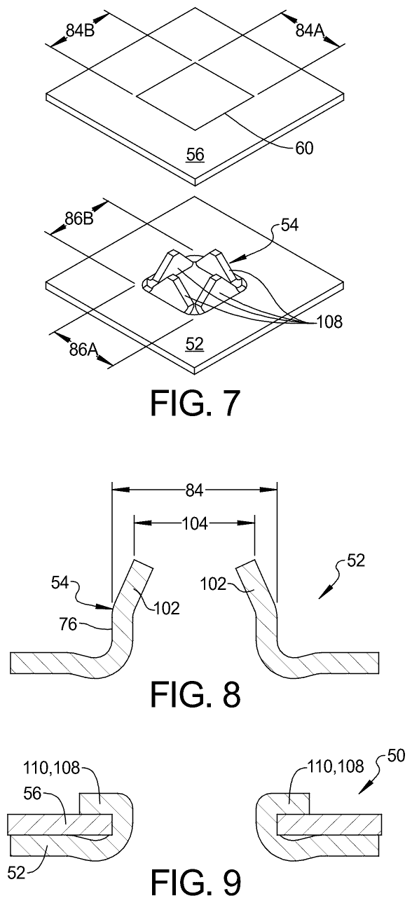

Referring again to FIG. 2, the locating opening 60 within the secondary component 56 has an inner dimension 84 and the locating boss 54 has an outer dimension 86 adapted to precisely position the secondary component 56 relative to the primary component 52. As shown, in FIG. 2, in an exemplary embodiment, the general shape of the locating opening 60 and the locating boss 54 is circular, wherein the inner dimension 84 of the locating opening 60 is an inner diameter and the outer dimension 86 of the locating boss is an outer diameter. As shown, in FIG. 7, in another exemplary embodiment, the general shape of the locating opening 60 and the locating boss 54 is square (four-sided), wherein the inner dimension 84 of the locating opening 60 includes an inner dimension 84A along an X-axis and an inner dimension 84B along a Y-axis, and the outer dimension 86 of the locating boss includes an outer dimension 86A along the X-axis and an outer dimension 86B along the Y-axis. It should be understood by those skilled in the art, that the general shape of the locating boss 54 and the corresponding shape of the locating opening 60 may be circular, oval, square, or any other polygonal shape.

The design and formation of the locating boss 54 is further described in related U.S. patent application Ser. No. 18/800,395, entitled “SELF-LOCATION FEATURES FOR COMPONENT ASSEMBLY”, filed on Aug. 12, 2024, the entire contents of which is hereby incorporated by reference.

To facilitate precise location of the secondary component 56 relative to the primary component 52, the tolerance between the inner dimension 84 of the locating opening 60 and the outer dimension 86 of the locating boss 54 must be close. In an exemplary embodiment, the inner dimension 84 of the locating opening 60 is slightly larger than the outer dimension 86 of the locating boss 54, wherein when the secondary component 56 is assembled to the primary component 52, referring to FIG. 5A, there will be clearance 88 between the locating opening 60 and the outer side wall 76, allowing very little movement of the secondary component 56, as indicated by arrow 90, relative to the primary component 52. The difference between the inner dimension 84 of the locating opening 60 and the outer dimension 86 of the locating boss 54 is carefully calibrated to maintain positional tolerances between the primary component 52 and the secondary component 56.

In another exemplary embodiment, the inner dimension 84 of the locating opening 60 is slightly smaller than the outer dimension 86 of the locating boss 54, wherein when the secondary component 56 is assembled to the primary component 52, there is an interference fit between the outer side wall 76 of the locating boss 54 and the locating opening 60, wherein no movement will be allowed between the secondary component 56 and the primary component 52.

Because the portion of the outer side wall 76 that extends above the first plane 70, as indicated at 82, is vertical relative to the first plane 70, and the fillet radius 80 of the locating boss 54 is positioned below the first plane 70, the secondary component 56 is able to be positioned directly onto the primary component 52, wherein the top surface 68 of the primary component 52 is in direct contact with an adjacent bottom surface 92 of the secondary component 56. Too much interference or the presence of the fillet radius 80 of the locating boss 54 being positioned above the first plane 70 would result in the secondary component 56 being suspended above the top surface 68 of the primary component 52.

Referring again to FIG. 5, in an exemplary embodiment, the primary component 52 includes an offset portion 94 extending along and immediately adjacent to the locating boss 54 and extending below the second plane 74. The offset portion 94 defines the recessed channel 78 within the top surface 68 of the primary component. A nominal thickness 96 of the primary component 52 and a thickness 98 of the offset portion 94 are uniform.

Referring to FIG. 6, in another exemplary embodiment, no portion of the bottom surface 72 of the primary component 52 extends below the second plane 74, and a portion of the primary component 52 that defines the recessed channel 78 within the top surface 68 of the primary component 52 has a thickness 100 that is less than the nominal thickness 96 of the primary component 52.

Referring to FIG. 8, in another exemplary embodiment the outer side wall 76 of the locating boss 54 includes a tapered profile tip 102. The tapered profile tip 102 provides a distal end dimension 104 that is narrower than the outer dimension 86 of the locating boss 54. This makes engagement of the locating boss 54 with the locating opening 60 easier during assembly.

In various embodiments, the locating boss 54 can include a continuous cylindrical or conical (tapered profile tip 102) wall 106, discontinuous flanges 108, or a combination of a continuous wall 106 and discontinuous flanges 108. Referring to FIG. 2, the circular locating boss 54 includes a continuous cylindrical wall portion 106 and a plurality (as shown four) of discontinuous flanges 108 that extend from the continuous cylindrical wall 106. Referring to FIG. 7, a square (and other polygonal shapes) locating boss 54 cannot have a continuous wall, but rather includes a plurality (four for the square shape as shown, five for a pentagon, six for a hexagon, etc.) of discontinuous flanges 108. Each of the plurality of flanges 108 includes a segment of recessed channel 78 extending along and immediately adjacent thereto.

Referring to FIG. 9, in another exemplary embodiment, the locating boss 54 includes portions 110 that are folded over onto the secondary component 56 to secure the secondary component 56 in position relative to the primary component 52. This feature is enabled in embodiments where the locating boss 54 includes discontinuous flanges 108, wherein a distal portion 110 of each of the discontinuous flanges 108 is folded over onto the secondary component 56.

A locating boss 54 of the present disclosure offers the advantage of allowing a secondary component 56 to be placed onto a primary component 52 with precise locating of the secondary component 56 relative to the primary component 52, wherein a fillet radius 80 of the locating boss 54 is positioned below a first plane 70 defined by a top surface 68 of the primary component 52, and thus, does not interfere with the secondary component 56 being positioned in direct contact with the top surface 68 of the primary component 52. Prior art solutions to interference by the fillet radius of the locating boss include increasing the inner dimension of the corresponding locating opening in the secondary component, however, this reduces the ability to precisely position the secondary component relative to the primary component. The novel features of the present disclosure allow precise positioning without interference from the fillet radius.

The description of the present disclosure is merely exemplary in nature and variations that do not depart from the gist of the present disclosure are intended to be within the scope of the present disclosure. Such variations are not to be regarded as a departure from the spirit and scope of the present disclosure.

1. A sheet metal component assembly, comprising:
a primary component having:
a top surface that defines a first plane;
a bottom surface that defines a second plane; and
a locating boss including a plurality of discontinuous flanges extending upward from the top surface and having an outer side wall, wherein a portion of the outer side wall of each of the plurality of discontinuous flanges that extends above the first plane is vertical relative to the first plane; and
a secondary component including a locating opening formed therein; and
wherein, the locating boss of the primary component engages the locating opening formed within the secondary component to position the secondary component relative to the primary component;
the top surface of the primary component including a recessed channel extending along and immediately adjacent to each one of the plurality of discontinuous flanges of the locating boss such that a fillet radius of each one of the plurality of discontinuous flanges of the locating boss is positioned below the first plane, and no portion of the bottom surface of the primary component extends below the second plane, and a portion of the primary component that defines the recessed channel extending along and immediately adjacent to each one of the plurality of discontinuous flanges within the top surface of the primary component has a thickness that is less than a nominal thickness of the primary component; and
prior to assembly of the primary component to the secondary component, the locating opening formed within the secondary component has an inner dimension that is smaller than an outer dimension of the locating boss of the primary component, such that, when the primary component is assembled to the secondary component, the locating boss of the primary component engages the locating opening formed within the secondary component with an interference fit between the locating boss and the locating opening.

2. (canceled)

3. The sheet metal component assembly of claim 1, wherein the top surface of the primary component is in direct contact with an adjacent surface of the secondary component.

4. The sheet metal component assembly of claim 3, wherein the primary component includes an offset portion extending along and immediately adjacent to each one of the plurality of discontinuous flanges of the locating boss and extending below the second plane, the offset portion defining the recessed channel extending along and immediately adjacent to each one of the plurality of discontinuous flanges within the top surface of the primary component.

5. (canceled)

6. (canceled)

7. (canceled)

8. The sheet metal component assembly of claim 3, wherein the locating boss includes a tapered profile tip.

9. The sheet metal component assembly of claim 3, wherein the locating boss includes portions that are folded over onto the secondary component to secure the secondary component in position relative to the primary component.

10. The sheet metal component assembly of claim 3, wherein the locating boss includes a continuous cylindrical or conical wall, and the plurality of discontinuous flanges extend from the continuous cylindrical or conical wall.

11. A rechargeable energy storage system (RESS), comprising:
a primary component that defines a tray and includes:
a top surface that defines a first plane;
a bottom surface that defines a second plane; and
a locating boss including a plurality of discontinuous flanges extending upward from the top surface and having an outer side wall, the top surface of the primary component including a recessed channel extending along and immediately adjacent to each one of the plurality of discontinuous flanges of the locating boss such that a fillet radius of each one of the plurality of discontinuous flanges of the locating boss is positioned below the first plane, wherein a portion of the outer side wall of each one of the plurality of discontinuous flanges that extends above the first plane is vertical relative to the first plane;
one or more RESS cells positioned within the primary component; and
a secondary component that defines a cover installed onto the primary component wherein the top surface of the primary component is in direct contact with an adjacent surface of the secondary component to enclose the RESS cells within the RESS, the secondary component including a locating opening formed therein; and
wherein, the locating boss of the primary component engages the locating opening formed within the secondary component to position the secondary component relative to the primary component;
the primary component including an offset portion extending along and immediately adjacent to each one of the plurality of discontinuous flanges of the locating boss and extending below the second plane, the offset portion defining the recessed channel extending along and immediately adjacent to each one of the plurality of discontinuous flanges within the top surface of the primary component, no portion of the bottom surface of the primary component extending below the second plane, and a portion of the primary component that defines the recessed channel extending along and immediately adjacent to each one of the plurality of discontinuous flanges within the top surface of the primary component having a thickness that is less than a nominal thickness of the primary component; and
prior to assembly of the primary component to the secondary component, the locating opening formed within the secondary component has an inner dimension that is smaller than an outer dimension of the locating boss of the primary component, such that, when the primary component is assembled to the secondary component, the locating boss of the primary component engages the locating opening formed within the secondary component with an interference fit between the locating boss and the locating opening.

12. (canceled)

13. (canceled)

14. The RESS of claim 11, wherein the locating boss includes a tapered profile tip.

15. The RESS of claim 11, wherein the locating boss includes portions that are folded over onto the secondary component to secure the secondary component in position relative to the primary component.

16. The RESS of claim 11, wherein the locating boss includes a continuous cylindrical or conical wall, and the plurality of discontinuous flanges extend from the continuous cylindrical or conical wall.

17. A vehicle having a rechargeable energy storage system (RESS) operably connected to a propulsion system of the vehicle, the RESS including:
a primary component that defines a tray and includes:
a top surface that defines a first plane;
a bottom surface that defines a second plane; and
a locating boss including a plurality of discontinuous flanges extending upward from the top surface and having an outer side wall, the top surface of the primary component including a recessed channel extending along and immediately adjacent to each one of the plurality of discontinuous flanges of the locating boss such that a fillet radius of each one of the plurality of discontinuous flanges of the locating boss is positioned below the first plane, wherein a portion of the outer side wall of each of the plurality of discontinuous flanges that extends above the first plane is vertical relative to the first plane;
one or more RESS cells positioned within the primary component; and
a secondary component that defines a cover installed onto the primary component wherein the top surface of the primary component is in direct contact with an adjacent surface of the secondary component to enclose the RESS cells within the RESS, the secondary component including a locating opening formed therein; and
wherein, the locating boss of the primary component engages the locating opening formed within the secondary component to position the secondary component relative to the primary component;
the primary component including an offset portion extending along and immediately adjacent to each one of the plurality of discontinuous flanges of the locating boss and extending below the second plane, the offset portion defining the recessed channel extending along and immediately adjacent to each one of the plurality of discontinuous flanges within the top surface of the primary component,
and
prior to assembly of the primary component to the secondary component, the locating opening formed within the secondary component has an inner dimension that is smaller than an outer dimension of the locating boss of the primary component, such that, when the primary component is assembled to the secondary component, the locating boss of the primary component engages the locating opening formed within the secondary component with an interference fit between the locating boss and the locating opening.

18. (canceled)

19. (canceled)

20. The vehicle of claim 17, wherein the locating boss includes a continuous cylindrical or conical wall, and the plurality of discontinuous flanges extend from the continuous cylindrical or conical wall.
